(19) United States
(12) Patent Application Publication
(10) Pub. No.: US 2019/0038505 A1
(43) Pub. Date: Feb. 7, 2019

(54) ACUPRESSURE THERAPEUTIC FOOT BAND FOR AND METHOD OF MENSTRUAL PAIN RELIEF

(71) Applicant: Airlie Christina Wedemeyer, Newport, NC (US)

(72) Inventor: Airlie Christina Wedemeyer, Newport, NC (US)

(21) Appl. No.: 16/034,606

(22) Filed: Jul. 13, 2018

Related U.S. Application Data
(60) Provisional application No. 62/541,912, filed on Aug. 7, 2017.

(51) Int. Cl. A61H 39/04; A43B 7/14

(52) U.S. Cl. CPC A61H 39/04; A61H 2201/165; A61H 2205/12; A43B 7/146

(57) ABSTRACT

An acupressure therapeutic foot band including a pressure pad configured to be worn by a wearer such that when worn the pressure pad is configured to be in pressure contact with an innerside of an ankle of the wearer and generally aligned with a uterus pressure point of the wearer. A method of using a therapeutic device the method may include positioning the therapeutic device about a wearer's foot; arranging the therapeutic device such that a pressure pad of the therapeutic device is positioned in pressure contact with a uterus pressure point; and securing the therapeutic device in place.

### RELATED APPLICATIONS

This application claims priority to and incorporates herein by reference related U.S. Provisional Patent Application No. 62/541,912 filed on Aug. 7, 2017.

### TECHNICAL FIELD

The presently disclosed subject matter relates generally to methods of menstrual pain relief and more particularly to an acupressure therapeutic foot band for and method of use for menstrual pain relief.

### BACKGROUND

Menstrual cramping (dysmenorrheal) is a medical condition characterized by severe uterine pain during menstruation. The condition is the result of contractions of the uterus as it expels unneeded contents and also the passage of clotted blood through the cervix. The underlying pain results when the uterine muscles contract too hard or fast resulting in severe discomfort around the abdomen, back, and often the legs. While most women only experience minor pain during menstruation, menstrual cramps are often so severe as to limit normal activities or may require medication.

According to the United States Department of Health and Human Services, roughly 52 percent of women in the United States between the ages of 15 to 51 suffer from some level of menstrual cramps. Of these, 10 percent have such a severe condition as to require a doctor visit. Statistics from the American College of Obstetrics and Gynecology reveal that menstrual cramping represents the number one cause of missed school and work days among women. Despite these alarming statistics, very little has been done to advance the art of treating menstrual cramping.

### SUMMARY OF THE INVENTION

In one embodiment, the invention provides a therapeutic device. The therapeutic device may include a pressure pad configured to be worn by a wearer such that when worn the pressure pad is configured to be in pressure contact with an innerside of an ankle of the wearer and generally aligned with a uterus pressure point of the wearer. The therapeutic device may further include an ankle strap; a stirrup strap having a first end and a second end, wherein the stirrup strap first end is positioned along a first portion of the ankle strap and the stirrup strap second end is on a second substantially opposing portion of the ankle strap; and wherein the pressure pad is on an inside portion of the ankle strap. The ankle strap may include a first end and a second end, wherein the stirrup strap first end is adjustably positioned along the first portion of the ankle strap and the stirrup strap second end is attached to the ankle strap second end. The pressure pad may be on an inside portion of the second end of the ankle strap. The ankle strap and stirrup strap may be made of a material having elastic properties. The ankle strap first end and second end may be configured to be releasably attachable to one another. When worn by the wearer, the ankle strap may be generally circular in shape and is configured to encircle the wearer's ankle, and wherein the stirrup strap is generally U shaped and is configured to extend from the first portion of the ankle strap under a sole of the wearer's foot and to the second substantially opposing portion of the ankle strap.

In another embodiment, the invention provides a method of using a therapeutic device. The method may include positioning the therapeutic device about a wearer's foot; arranging the therapeutic device such that a pressure pad of the therapeutic device is positioned in pressure contact with a uterus pressure point; and securing the therapeutic device in place.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 illustrates an example of the presently disclosed acupressure therapeutic foot bands;

FIG. 2 illustrates another example of the presently disclosed acupressure therapeutic foot bands;

FIG. 3 and FIG. 4 illustrate an example of the presently disclosed acupressure therapeutic foot bands while being worn;

FIG. 5 illustrates a flow diagram of an example of a method of putting on and using the presently disclosed acupressure therapeutic foot bands; and

FIG. 6 illustrates a general location of a uterus pressure point on a human's foot.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

In some embodiments, the presently disclosed subject matter provides an acupressure therapeutic foot band for and method of menstrual pain relief. Namely, the presently disclosed acupressure therapeutic foot band may include an ankle strap, a stirrup or foot strap, and a pressure pad or knob, wherein the pressure pad or knob can be positioned against the uterus pressure point located on the inner ankle. In the acupressure therapeutic foot band, the pad or knob is used to apply pressure to the uterus pressure point resulting in partial or full relief of menstrual cramps.

Further, the presently disclosed acupressure therapeutic foot band provides a pressure mechanism for the ankle that is comfortable and can be set at a desired tightness. Both a left and a right acupressure therapeutic foot band may be provided.

An aspect of the presently disclosed acupressure therapeutic foot bands is that they can be used to relieve women of menstrual cramps rapidly and almost entirely, replacing the need for pain medication for women who are intolerant of pain medication, whose current medications conflict with pain medication, and/or women seeking alternate relief other than pain medication.

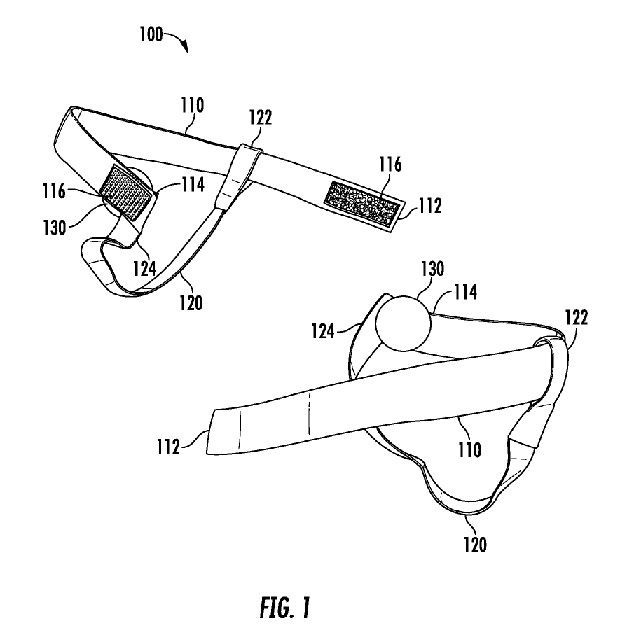

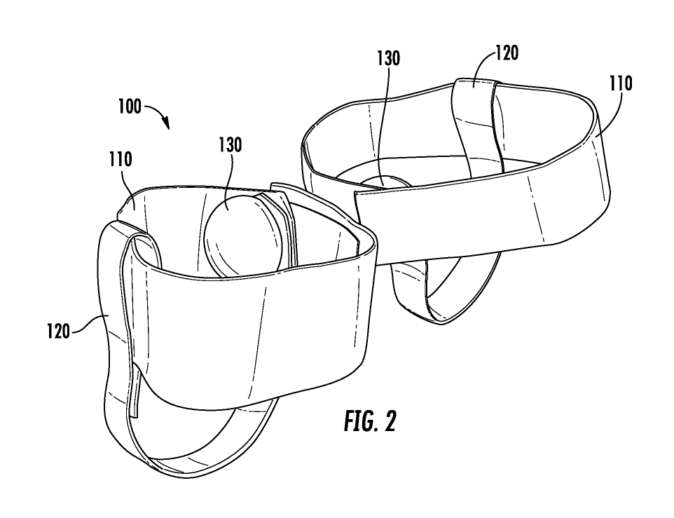

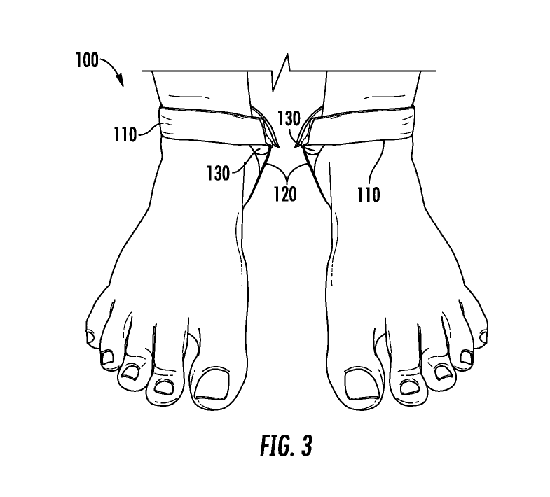

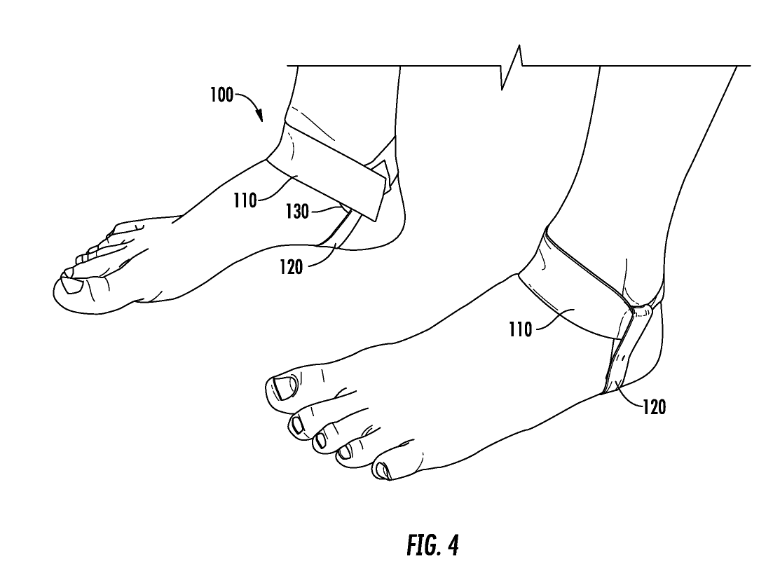

Referring now to FIG. 1 is an example of the presently disclosed acupressure therapeutic foot bands 100. FIG. 2 shows a process of putting on the presently disclosed acupressure therapeutic foot bands 100. FIG. 3 and FIG. 4 show an example of the presently disclosed acupressure therapeutic foot bands 100 while being worn. Namely, a left acupressure therapeutic foot band 100 and a right acupressure therapeutic foot band 100 is provided.

Each acupressure therapeutic foot band 100 preferably includes an ankle strap 110, a stirrup (or foot) strap 120, and a pressure pad 130. Ankle strap 110 and stirrup strap 120 may be stretchable elastic straps. Ankle strap 110 and stirrup strap 120 may be made of any suitable stretchable elastic material, including but not limited to neoprene, elastane, rubber, and/or the like. Ankle strap 110 can be, for example, about 1 inch wide and stirrup strap 120 can be, for example, about 0.5 inches wide. Ankle strap 110 has a first end 112 and a second end 114. Further, hook-and-loop fasteners 116 may be provided on both first end 112 and second end 114 of ankle strap 110. An example of hook-and-loop fasteners 116 is the Velcro® brand hook-and-loop fasteners. Other suitable fasteners may be used as an alternative to hook-and-loop fasteners 116, including but not limited to, snaps, buckles, buttons, and/or any other suitable technique or mechanism. Pressure pad 130 is preferably installed on an inside surface portion of ankle strap 110 and proximal to second end 114. For example, pressure pad 130 may be a rubber pad or knob that is attached to the inside of second end 114 of ankle strap 110. Pressure pad 130 may be made of other materials, for example, plastic, wood, metal, silicone, balled fabric, stuffed fabric, or any other suitable material. Pressure pad 130 can be, for example, a disc-shaped pad that is about one (1) inches in diameter and about a one-half inches thick. Pressure pad 130 may alternatively be, for example, spherical, ovular, or other suitable shape.

Stirrup strap 120 may have a loop end 122 and a second end 124. The loop end 122 of stirrup strap 120 is preferably slideably installed along ankle strap 110, while second end 124 of stirrup strap 120 is preferably fastened (e.g., by stitching, adhesive, or other suitable technique or mechanism) to second end 114 of ankle strap 110.

The overall arrangement of ankle strap 110, stirrup strap 120, and pressure pad 130 of the left acupressure therapeutic foot band 100 is a mirror image of the overall arrangement of ankle strap 110, stirrup strap 120, and pressure pad 130 of the right acupressure therapeutic foot band 100.

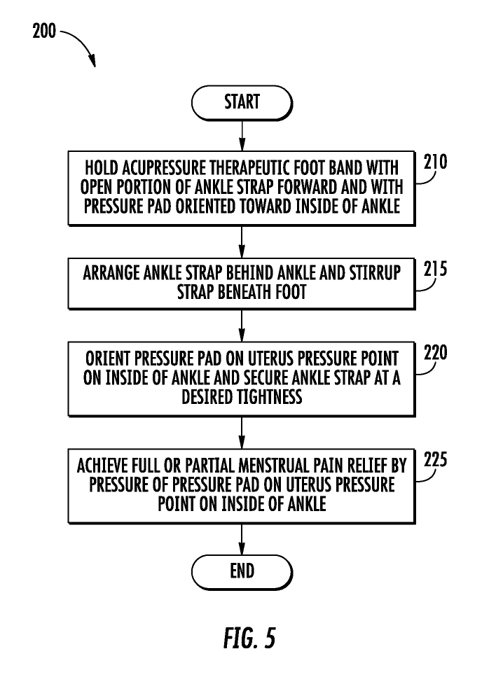

FIG. 5 illustrates a flow diagram of an example of a method 200 of putting on and using the presently disclosed acupressure therapeutic foot bands 100. Method 200 is performed with the left acupressure therapeutic foot band 100 and the user's left foot. Method 200 may also be performed with the right acupressure therapeutic foot band 100 and the user's right foot. Method 200 may include, but it not limited to, the following steps.

At a step 210, acupressure therapeutic foot band 100 is held with the open portion of ankle strap 110 facing forward and with pressure pad 130 oriented toward the inside of the ankle. For example, the left acupressure therapeutic foot band 100 is held with the open portion of ankle strap 110 facing forward and with pressure pad 130 oriented toward the inside of the left ankle. In like manner, the right acupressure therapeutic foot band 100 is held with the open portion of ankle strap 110 facing forward and with pressure pad 130 oriented toward the inside of the right ankle.

At a step 215, ankle strap 110 is arranged behind the ankle and stirrup strap 120 is arranged beneath the foot. Namely, for both the left and right acupressure therapeutic foot band 100, ankle strap 110 is arranged behind the ankle and stirrup strap 120 is arranged beneath the foot.

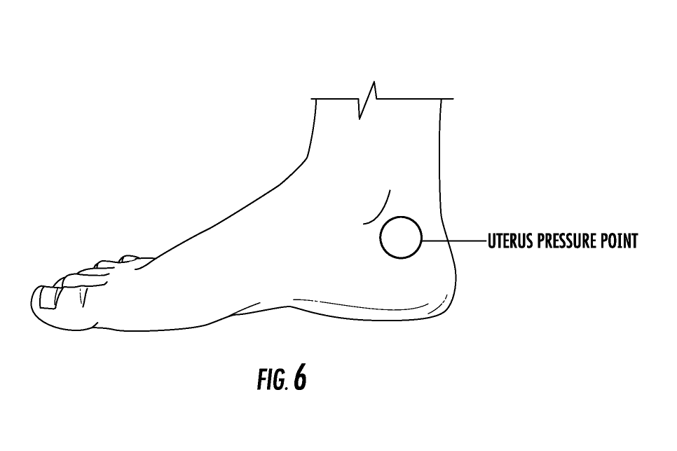

At a step 220, pressure pad 130 is oriented on the uterus pressure point on the inside of the ankle and then ankle strap 110 is secured around the ankle at a desired tightness. Namely, first end 112 of ankle strap 110 is pulled toward and secured to second end 114 of ankle strap 110 via a fastener, such as, hook-and-loop fasteners 116, wherein ankle strap 110 is pulled to a desired tightness and pressure pad 130 is applying pressure to the uterus pressure point located on the medial side of the foot, about halfway between the back of the heel and the anklebone (see for example the red circled are as shown in FIG. 6).

At a step 225, full or partial menstrual pain relief is achieved by the pressure of pressure pad 130 on the uterus pressure point on the inside of ankle. For example, full or partial menstrual pain relief is achieved by the pressure of pressure pad 130 of the left acupressure therapeutic foot band 100 on the uterus pressure point on the inside of the left ankle. In like manner, full or partial menstrual pain relief is achieved by the pressure of pressure pad 130 of the right acupressure therapeutic foot band 100 on the uterus pressure point on the inside of the right ankle.

In other embodiments, ankle strap 110 of acupressure therapeutic foot bands 100 may not be a strap that is opened and closed using hook-and-loop fasteners 116. Instead, ankle strap 110 may be a continuous elastic band with stirrup strap 120 attached thereto, wherein the user simply slips their foot into the looped ankle strap 110 and stirrup strap 120. The user then pulls the acupressure therapeutic foot band 100 into proper position around the ankle. Further, acupressure therapeutic foot bands 100 can be provided in different sizes, such as small, medium, large, and extra-large.

The presently disclosed acupressure therapeutic foot bands 100 and method 200 can be used to relieve women of menstrual cramps rapidly and almost entirely, replacing the need for pain medication for women who are intolerant of pain medication, whose current medications conflict with pain medication, and/or women seeking alternate relief other than pain medication.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A therapeutic device, comprising a pressure pad configured to be worn by a wearer such that when worn the pressure pad is configured to be in pressure contact with an innerside of an ankle of the wearer and generally aligned with a uterus pressure point of the wearer.

2. The device of claim 1 further, comprising:
a. an ankle strap; and
b. a stirrup strap having a first end and a second end, wherein the stirrup strap first end is positioned along a first portion of the ankle strap and the stirrup strap second end is on a second substantially opposing portion of the ankle strap; and
wherein the pressure pad is on an inside portion of the ankle strap.

3. The device of claim 2 wherein the ankle strap comprises a first end and a second end, wherein the stirrup strap first end is adjustably positioned along the first portion of the ankle strap and the stirrup strap second end is attached to the ankle strap second end.

4. The device of claim 3 wherein the pressure pad is on an inside portion of the second end of the ankle strap.

5. The device of claim 2 wherein the ankle strap and stirrup strap comprise a material having elastic properties.

6. The device of claim 3 wherein the ankle strap first end and second end are configured to be releasably attachable to one another.

7. The device of claim 2 wherein, when worn by the wearer, the ankle strap is generally circular in shape and is configured to encircle the wearer's ankle, and wherein the stirrup strap is generally U shaped and is configured to extend from the first portion of the ankle strap under a sole of the wearer's foot and to the second substantially opposing portion of the ankle strap.

8. A method of using a therapeutic device, comprising:
a. positioning the therapeutic device about a wearer's foot;
b. arranging the therapeutic device such that a pressure pad of the therapeutic device is positioned in pressure contact with a uterus pressure point; and
c. securing the therapeutic device in place.

9. The method of claim 8 wherein the therapeutic device comprise:
a. an ankle strap;
b. a stirrup strap having a first end and a second end, wherein the stirrup strap first end is positioned along a first portion of the ankle strap and the stirrup strap second end is on a second substantially opposing portion of the ankle strap; and
c. a pressure pad on an inside portion of the ankle strap.

10. The method of claim 9 wherein the ankle strap comprises a first end and a second end, wherein the stirrup strap first end is adjustably positioned along the first portion of the ankle strap and the stirrup strap second end is attached to the ankle strap second end.

11. The method of claim 10 wherein the pressure pad is on an inside portion of the second end of the ankle strap.

12. The method of claim 9 wherein the ankle strap and stirrup strap comprise a material having elastic properties.

13. The method of claim 10 wherein the ankle strap first end and second end are configured to be releasably attachable to one another.

14. The method of claim 9 wherein when worn by the wearer, the ankle strap is generally circular in shape and is configured to encircle the wearer's ankle, and wherein the stirrup strap is generally U shaped and is configured to extend from the first portion of the ankle strap under a sole of the wearer's foot and to the second substantially opposing portion of the ankle strap.
